(19) United States
(12) Patent Application Publication
(10) Pub. No.: US 2022/0042362 A1
(43) Pub. Date: Feb. 10, 2022

(54) VEHICULAR DOOR HINGE WITH FOLDED SHEET METAL COMPONENT

(71) Applicant: Warren Industries Ltd., Concord, CA (US)

(72) Inventors: David FREEDMAN, Toronto (CA); Sven SAUERWEIN, Newmarket (CA); John MOERMAN, Maple (CA)

(21) Appl. No.: 17/305,581

(22) PCT Filed: Jan. 20, 2020
(86) PCT No.: PCT/CA2020/050055

§ 371 Date: Jul. 9, 2021

Related U.S. Application Data
(60) Provisional application No. 62/793,913, filed on Jan. 18, 2019.

(51) Int. Cl. E05D 5/06; E05D 3/02; E05D 5/12; E05D 7/10; E05D 11/06

(52) U.S. Cl. CPC E05D 5/062; E05D 3/02; E05D 2005/102; E05D 7/1061; E05D 11/06; E05D 5/12

(57) ABSTRACT

In an aspect, a vehicular door hinge is provided and includes a door-hinge component that is configured to mount to a vehicle door and a body-hinge component that is configured to mount to a vehicle body. The door hinge component is pivotally mounted to the body hinge component. A first one of the door- and body-hinge components is made from folded sheet metal and has a fold. Each of the door- and body-hinge components has a stop surface that is engageable with the stop surface on the other of the door- and body-hinge components to limit relative pivoting movement between the door- and body-hinge components. The stop surface on the first of the door- and body-hinge components is at the fold.

### CROSS-REFERENCE TO RELATED APPLICATIONS

This application claims the benefit of 62/793,913, filed Jan. 18, 2019, the contents of which are incorporated herein by reference in their entirety.

### FIELD

The specification relates generally to vehicular door hinges, and in particular, to door hinges made with sheet metal.

### BACKGROUND OF THE DISCLOSURE

In the vehicular arts, it is generally beneficial to provided components and assemblies that are made to perform well but at low cost. One such area that benefit from such development is vehicular door hinges.

### SUMMARY OF THE DISCLOSURE

In an aspect, a vehicular door hinge is provided and includes a door-hinge component that is configured to mount to a vehicle door and a body-hinge component that is configured to mount to a vehicle body. The door hinge component is pivotally mounted to the body hinge component. A first one of the door- and body-hinge components is made from folded sheet metal and has a fold. Each of the door- and body-hinge components has a stop surface that is engageable with the stop surface on the other of the door- and body-hinge components to limit relative pivoting movement between the door- and body-hinge components. The stop surface on the first of the door- and body-hinge components is at the fold.

In another aspect, a vehicular door hinge is provided and includes a door-hinge component that is configured to mount to a vehicle door, and a body-hinge component that is configured to mount to a vehicle body. The door hinge component is pivotally mounted to the body hinge component. A first one of the door- and body-hinge components is made from folded sheet metal and has a fold. Each of the door- and body-hinge components has a stop surface that is engageable with the stop surface on the other of the door- and body-hinge components to limit relative pivoting movement between the door- and body-hinge components. The first one of the door- and body-hinge components includes a first layer of sheet metal and a second layer of sheet metal. One of the first and second layers has a layer-locking aperture therein, and the other of the first and second layers has a deformation that projects into the layer-locking aperture so as to lock the first and second layers together in at least one plane of movement.

In another aspect, a vehicular door hinge is provided and includes a door-hinge component that is configured to mount to a vehicle door, and a body-hinge component that is configured to mount to a vehicle body. The door hinge component is pivotally mounted to the body hinge component. A first one of the door- and body-hinge components is made from folded sheet metal and has a fold. Each of the door- and body-hinge components has a stop surface that is engageable with the stop surface on the other of the door- and body-hinge components to limit relative pivoting movement between the door- and body-hinge components. A hinge pin having a first bearing surface and a second bearing surface. The hinge pin passes through a first hinge pin aperture in the door-hinge component and through a second hinge pin aperture in the body-hinge component. One of the first and second hinge pin apertures is non-round. A corresponding one of the first and second bearing surfaces is non-round and complementary to said one of the first and second hinge pin apertures so as to rotationally lock the hinge pin to whichever of the door- and body-hinge components has said one of the first and second hinge pin apertures.

### BRIEF DESCRIPTIONS OF THE DRAWINGS

For a better understanding of the various embodiments described herein and to show more clearly how they may be carried into effect, reference will now be made, by way of example only, to the accompanying drawings in which:

FIG. 1 is a perspective view of a portion of a vehicle including a portion of a vehicle body and a portion of a vehicle door, which is mounted to the vehicle body via first and second vehicular door hinges in accordance with an embodiment of the present disclosure.

FIG. 2A is a magnified perspective view of one of the vehicular door hinges shown in FIG. 1, in a closed position.

FIG. 2B is a magnified perspective view of one of the vehicular door hinges shown in FIG. 1, in an open position.

FIG. 3 is a perspective exploded view of the vehicular door hinge shown in FIG. 2A.

FIG. 4 is a sectional perspective view of the vehicular door hinge shown in FIG. 2A.

FIG. 5 is another sectional perspective view of the vehicular door hinge shown in FIG. 2A.

FIG. 6 is a perspective view of a vehicular door hinge in accordance with another embodiment of the present disclosure, in a closed position.

FIG. 7 is a perspective exploded view of the vehicular door hinge shown in FIG. 6.

FIG. 8 is a sectional perspective view of the vehicular door hinge shown in FIG. 6.

FIG. 9A is a perspective view of a vehicular door hinge in accordance with another embodiment of the present disclosure, in a closed position.

FIG. 9B is a perspective view of the vehicular door hinge in accordance with another embodiment of the present disclosure, in an open position.

FIG. 10 is a perspective exploded view of the vehicular door hinge shown in FIG. 9A.

FIG. 11 is a perspective view of the vehicular door hinge in accordance with another embodiment of the present disclosure, in a closed position.

FIG. 12 is a perspective exploded view of the vehicular door hinge shown in FIG. 11.

FIG. 13 is a front sectional view of a body-hinge component from the vehicular door hinge shown in FIG. 11.

FIG. 14 a perspective view of the vehicular door hinge in accordance with another embodiment of the present disclosure, in a closed position.

FIG. 15 is a perspective exploded view of the vehicular door hinge shown in FIG. 14.

FIG. 16 a perspective view of the vehicular door hinge in accordance with another embodiment of the present disclosure, in a closed position.

FIG. 17 is a perspective exploded view of the vehicular door hinge shown in FIG. 16.

FIG. 18 is a front sectional view of a body-hinge component from the vehicular door hinge shown in FIG. 16.

### DETAILED DESCRIPTION

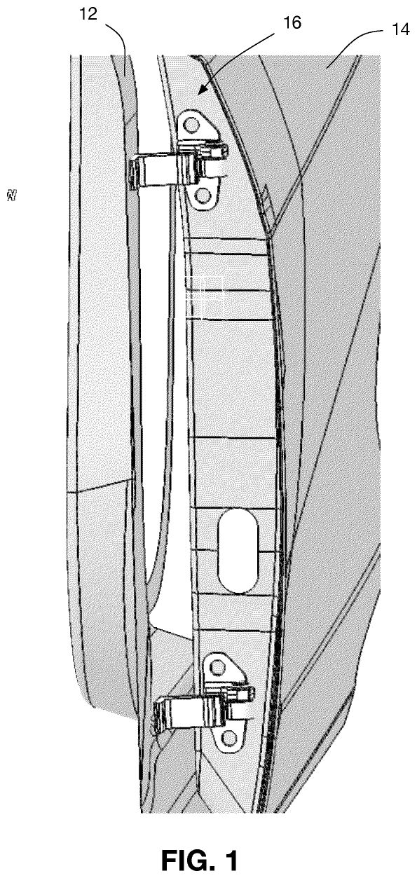

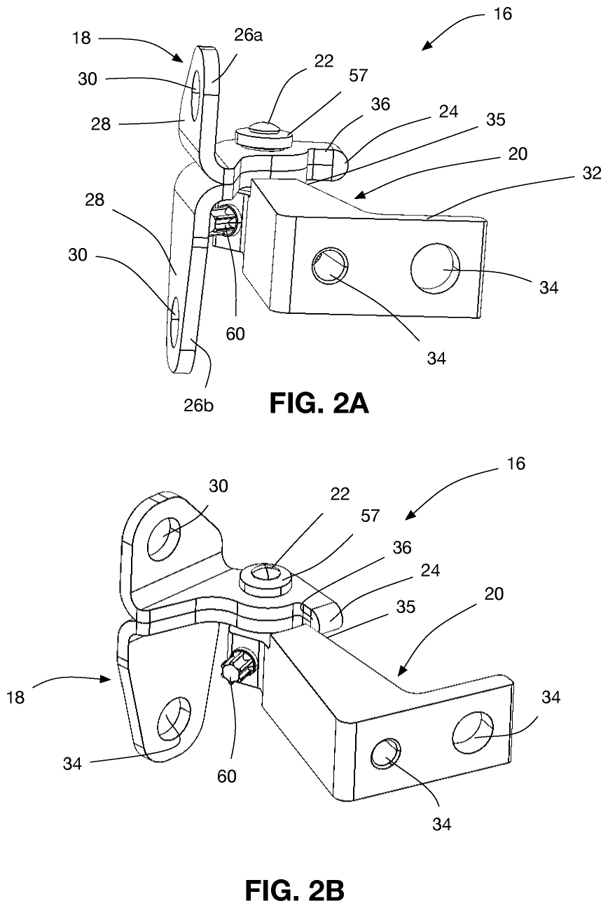

Reference is made to FIG. 1, which shows a portion of a vehicle 10 including a portion of a vehicle body 12 and a portion of a vehicle door 14, which is mounted to the vehicle body via two vehicular door hinges 16 in accordance with an embodiment of the present disclosure. One of the vehicular door hinges 16 is shown more clearly in FIG. 2A in a closed position, and in FIG. 2B in an open position. The hinge 16 includes a door-hinge component 18 that is configured to mount to the vehicle door 14 and a body-hinge component 20 that is configured to mount to the vehicle body 12. The door hinge component 18 is pivotally mounted to the body hinge component 20. This may be by virtue of a hinge pin 22, which is described further below.

A first one of the door- and body-hinge components 18 and 20 is made from folded sheet metal (e.g. sheet steel). In the present example, this is the door-hinge component 18. As can be seen, the door-hinge component 18 has a fold 24, and has a first layer 26a and a second layer 26b, each of which include a bend to form a base 28 with a mounting aperture 30. The mounting apertures 30 align with similar apertures (not shown, but which is well known to a person skilled in the art) on the vehicle door 14 for the pass-through of mounting fasteners so as to hold the door-hinge component 18 to the vehicle door 14.

In the present example, the other of the door- and body-hinge components 18 and 20 is made from a monolithic material (e.g. steel) and may, for example be a part that is machined from an extrusion. In the present example, this is the body-hinge component 20. The body-hinge component has a base 32 that includes first and second mounting apertures 34 which align with similar apertures (not shown, but which are well known to a person skilled in the art) on the vehicle door 14 for receiving mounting fasteners (not shown) so as to hold the body-hinge component 20 to the vehicle body 12. In the present example, one of the second mounting apertures 34 is a blind aperture, though in other example, both apertures may be pass-through apertures.

Each of the door- and body-hinge components 18 and 20 has a stop surface that is engageable with the stop surface on the other of the door- and body-hinge components 18 and 20, to limit relative pivoting movement between the door- and body-hinge components 18 and 20. The stop surface on the body-hinge component 20 is shown at 35 and the stop surface on the door-hinge component is shown at 36.

The positions of the stop surfaces 35 and 36 set a maximum open position for the vehicle door 12. The stop surface 35 in the present example is a surface of the machined part (i.e. of the monolithic body-hinge component 20). The stop surface on the door-hinge component 18 is at the fold 24. The fold 24 of the door-hinge component 18 is a naturally strong region of the door-hinge component 18, and is able to withstand higher forces without resulting in deformation of the door-hinge component 18. By using the fold 24 to act as the stop surface 36 and to engage the stop surface 35, a separate means of strengthening the door-hinge component 18 need not be provided. By contrast, in some vehicular door hinges of the prior art, the analogous door-hinge component is itself a machined part, or is provided with separate reinforcement to provide sufficient strength to resist deformation. However, this can result in a door-hinge component that is relatively expensive. By employing the fold 24 in the present door-hinge component 18 to provide the stop surface 36, the door-hinge component 18 has sufficient strength for the purpose while being less expensive than a door-hinge component in some other door hinges of the prior art.

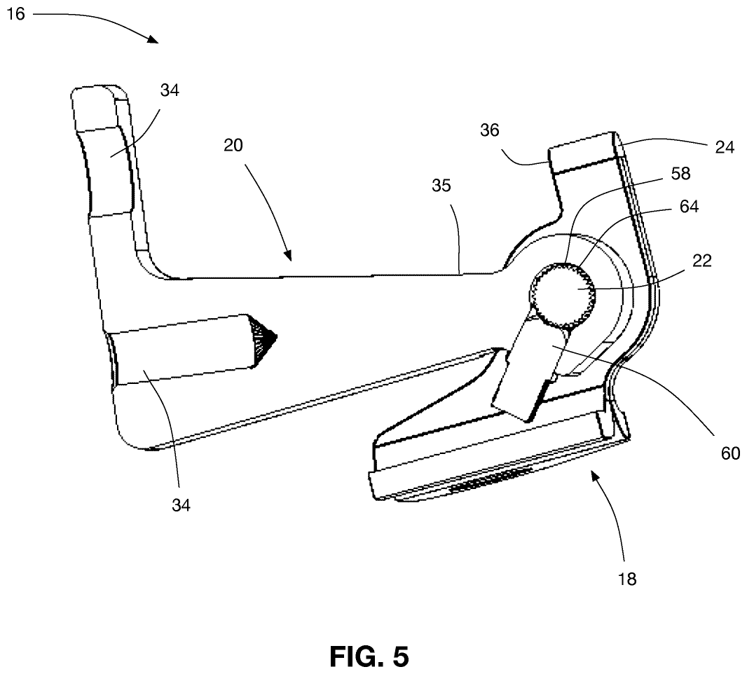

It will be understood that the example shown in FIGS. 1-5 is but an example, and that the first one of the door- and body-hinge components, which is formed from folded sheet metal and includes a fold, could alternatively be the body-hinge component instead of being the door-hinge component.

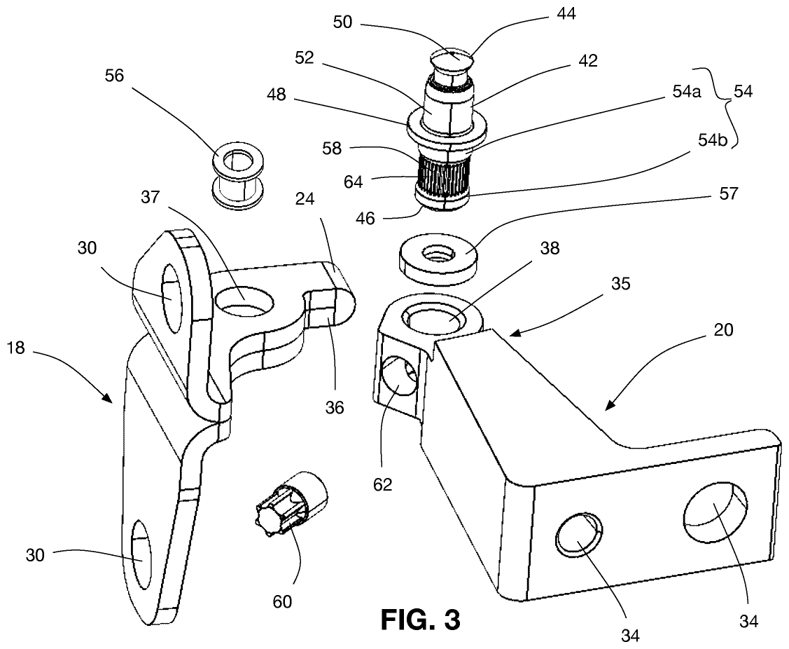

In the present example, the vehicular door hinge 16 is a lift-off type of door hinge, which means that the door-hinge component 18 can be removed from the body-hinge component 20. In the present example, the hinge pin 22 passes through a first hinge pin aperture 37 (best seen in FIG. 3) in the door-hinge component 18 and through a second hinge pin aperture 38 in the body-hinge component 20. The hinge pin 22 has a hinge pin body 42 with a first end 44 and a second end 46, and has a first flange 48 extending outward from the hinge pin body 42 at a point that is between the first and second ends 44 and 46, and a second flange 50 at the first end 44, such that the first and second flanges 48 and 50 capture the door-hinge component 18. The second flange 50 may be formed by hammering a head on the first end 44 to form a rivet.

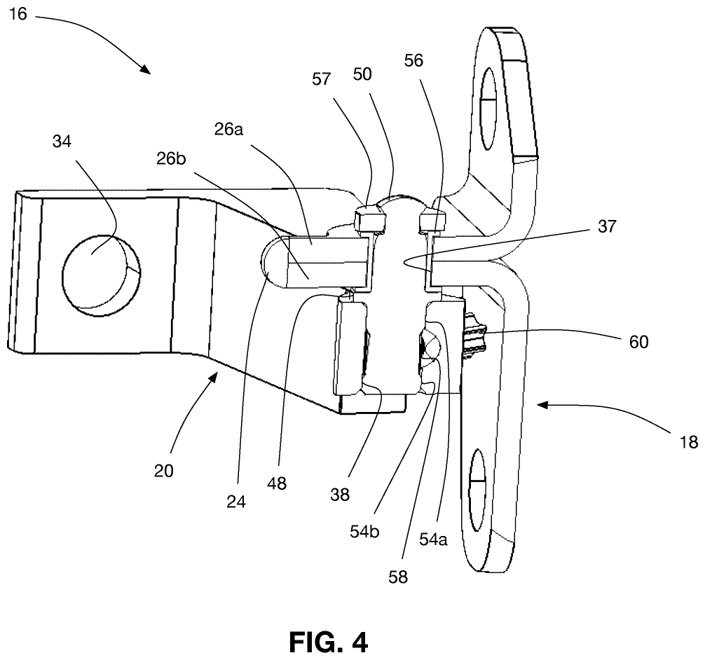

The hinge pin body 42 has a first bearing surface 52 between the first and second flanges 48 and 50 and a second bearing surface 54 between the second flange 50 and the second end 44. A bushing 56 (FIGS. 3 and 4) may be provided between the first bearing surface 52 and the first hinge pin aperture 37 so as to facilitate pivoting movement of the door-hinge component 18 relative to the hinge pin 22 and to prevent wear of either the door-hinge component 18 and the hinge pin 22 during such pivoting movement.

A washer 57 is provided between the second flange 50 and the bushing 56. This permits the hammering of the head on the first end 44 without damaging the bushing 56.

The second bearing surface 54 has a depression 58 between the second flange 50 and the second end 44. In the present example, the depression 58 splits the second bearing surface 54 into a first portion 54a and a second portion 54b. The vehicular door hinge 16 further includes a locking screw 60 that passes through a threaded aperture 62 in the body-hinge component 20 and into the depression 58 so as to releasably lock the hinge pin 22 to the body-hinge component 20. The depression 58 may have a knurled surface 64 (FIGS. 3, 4 and 5) to improve the grip of the locking screw 60 thereon. The locking screw 60 is removable to permit removal of the hinge pin 22 from the other of the body-hinge component 20, so as to permit removal of the vehicle door 14 from the vehicle body 12.

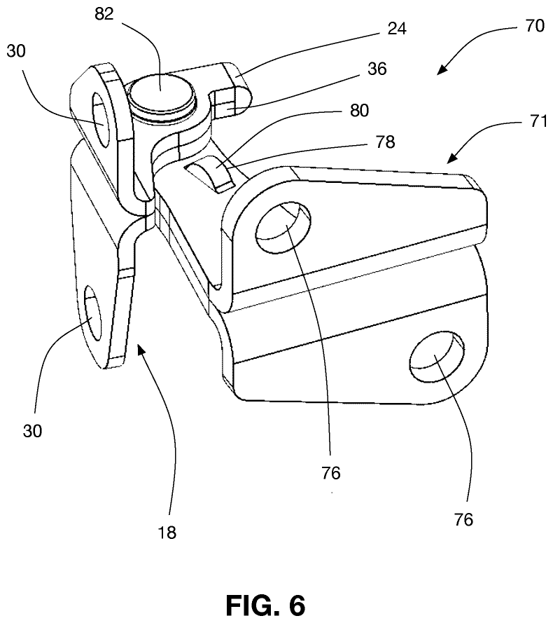

Reference is made to FIGS. 6-8 which show a vehicular door hinge 70 in accordance with another embodiment of the present disclosure. In the vehicular door hinge 70 the door-hinge component 18 may be substantially identical to the door-hinge component 18 shown in FIGS. 2A-5. The body-hinge component 20 may be replaced by a body-hinge component 71 that is similar to the body-hinge component 20 shown in FIGS. 2A-5 but with some differences as described below. The body-hinge component 71 may also be formed from sheet metal, optionally folded sheet metal, similar to the door-hinge component 18. The body-hinge component 71 includes a first layer 72a and a second layer 72b, which extend from a fold 74. Each layer 72a and 72b has a bend to form a base 75, which includes a mounting aperture 76, for aligning with mounting apertures (not shown) in the vehicle body 12.

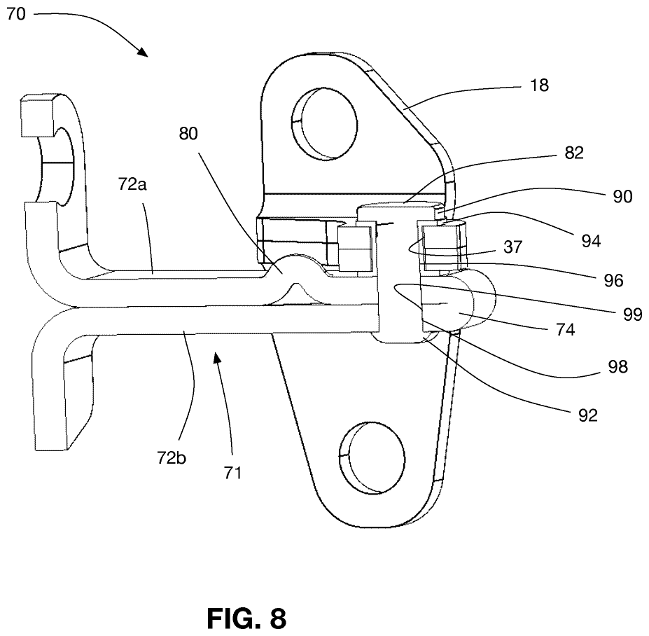

The stop surface is shown at 78 and is provided on a lanced region 80 (FIG. 8) of the body-hinge component 71 and more specifically of the first layer 72a of the body-hinge component 71. The stop surface 36 on the door-hinge component 18 engages the stop surface 78 in similar manner to the engagement of the stop surface 36 with the stop surface 35 on the body-hinge component 20. Throughout this disclosure reference is made to first and second layers for the body-hinge component in at least some embodiments, and first and second layers for the door-hinge component. It will be understood that, for each component, the first layer could alternatively be the second layer and the second layer could alternatively be the first layer. Furthermore, where features are described as being provided on a first layer of one of the components, it will be understood that those features could alternatively be provided on the second layer of those components.

In the present example, the vehicular door hinge 70 is not a lift-off type of hinge. The hinge pin is shown at 82 and includes a hinge pin body 84 that has a first end 86 and a second end 88, wherein a first flange 90 is provided at the first end 86 and a second flange 92 (formed by a hammering process) is provided at the second end 88. A bushing 94 is provided between the first bearing surface (shown at 96) of the hinge pin body 84 and the first hinge pin aperture 37 in the door-hinge component 18. The second bearing surface 98 (which may be contiguous with the first bearing surface 96) may directly engage a second hinge pin aperture 99 provided in the door-hinge component 71.

By forming the body-hinge component 71 from sheet metal, the body-hinge component 71 may further reduce the cost of the vehicular door hinge 70 relative to some door hinges of the prior art.

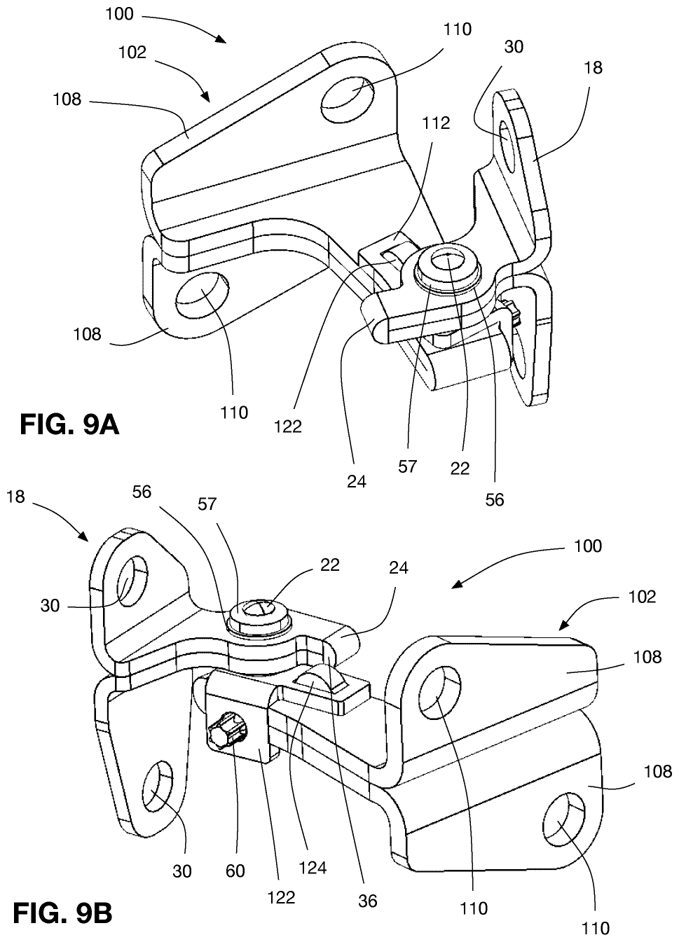

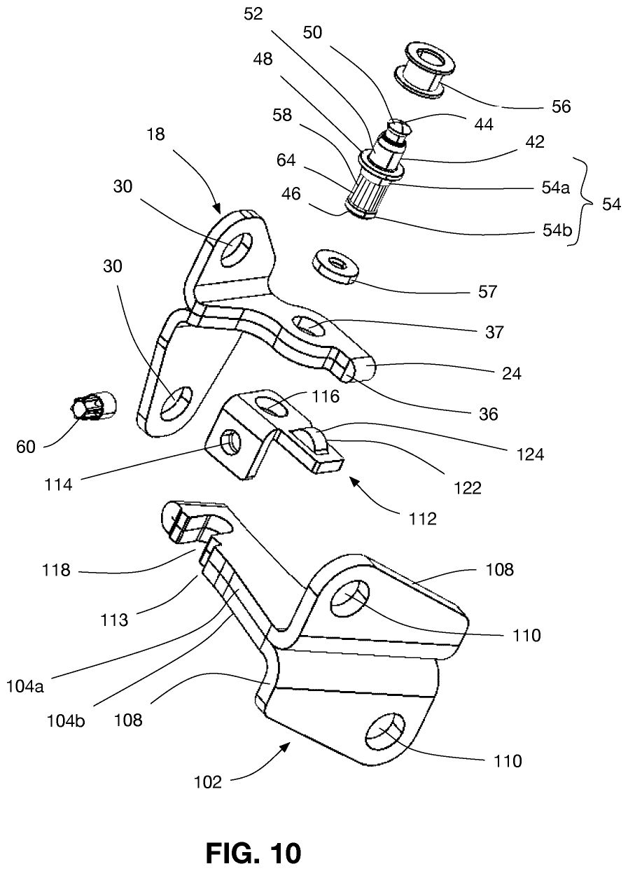

Reference is made to FIGS. 9A, 9B and 10 which show a vehicular door hinge 100 in accordance with another embodiment of the present disclosure. In the vehicular door hinge 70 the door-hinge component 18 may be substantially identical to the door-hinge component 18 shown in FIGS. 2A-5. Additionally, the hinge pin 22, bushing 56 and washer 57 may also be substantially identical to the hinge pin 22 shown in FIGS. 2A-5. A body-hinge component 102 may be provided that is similar to the body-hinge components 20 and 71 but with some differences as described below. The body-hinge component 102 may be made from folded sheet metal, similar to the body-hinge component 71 and may thus include a first layer 104a and a second layer 104b which extend from a fold 106 each of which has a bend to form a base 108 with a mounting aperture 110 to align with a respective mounting aperture on the vehicle body 12.

The body-hinge component 102 further includes an aperture plate 112 that is mounted to the first and second layers 104a and 104b by any suitable means such as by welding into a notch 113 formed in the edges of both the first and second layers 104a and 104b. The aperture plate 112 includes a threaded aperture 114 that is similar to the threaded aperture 62 that is provided in the machined body-hinge component 20, for receiving the locking screw 60 so as to permit the releasable locking of the hinge pin 22 to the body-hinge component 102. The aperture plate 112 has a first hinge pin aperture portion 116 that cooperates with a second hinge pin aperture portion 118 on the body-hinge component 102 to form the second hinge pin aperture. The second hinge pin aperture portion 118 may be formed by a cutout in the first and second layers 104a and 104b.

Optionally, the aperture plate 112 may include the stop surface shown at 122, which may be provided on a lanced region 124 of the aperture plate 112. In this way, the aperture plate 112, which is small relative to the sheet metal forming the remainder of the body-hinge component 102, can be made from a stronger material (e.g. by way of material thickness or material composition) than the sheet metal forming the remainder of the 102, thereby providing strength where desired (e.g. for the threaded aperture 114, for the hinge pin aperture portion 116 and for the stop surface 122, with relatively little added cost.

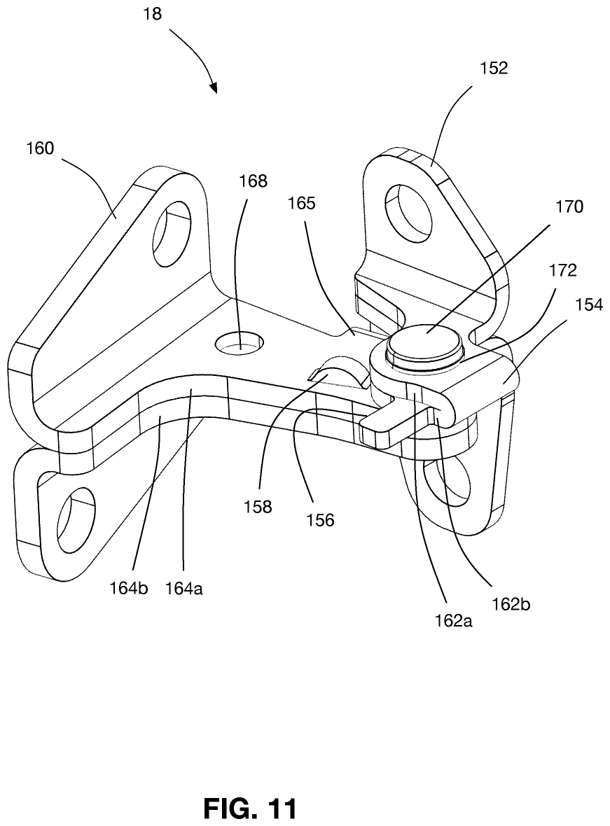

Reference is made to FIGS. 11, 12 and 13, which show a vehicular door hinge 150 in accordance with another embodiment of the present disclosure. In the vehicular door hinge 150 a door-hinge component 152 is provided that is similar to the door-hinge component 18 shown in FIGS. 1-10, but has a fold 154 that is spaced from, and is parallel to, the stop surface shown at 156 that engages the stop surface shown at 158 on the body-hinge component shown at 160. The stop surface 156 is provided on a projection on one of the first and second layers shown at 162a and 162b that extend from the fold 154. In the present example the projection is on the second layer 162b.

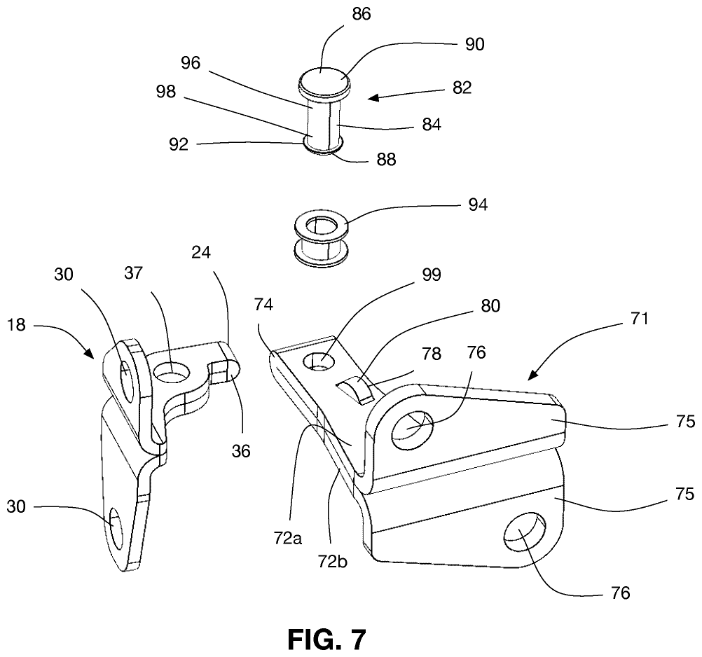

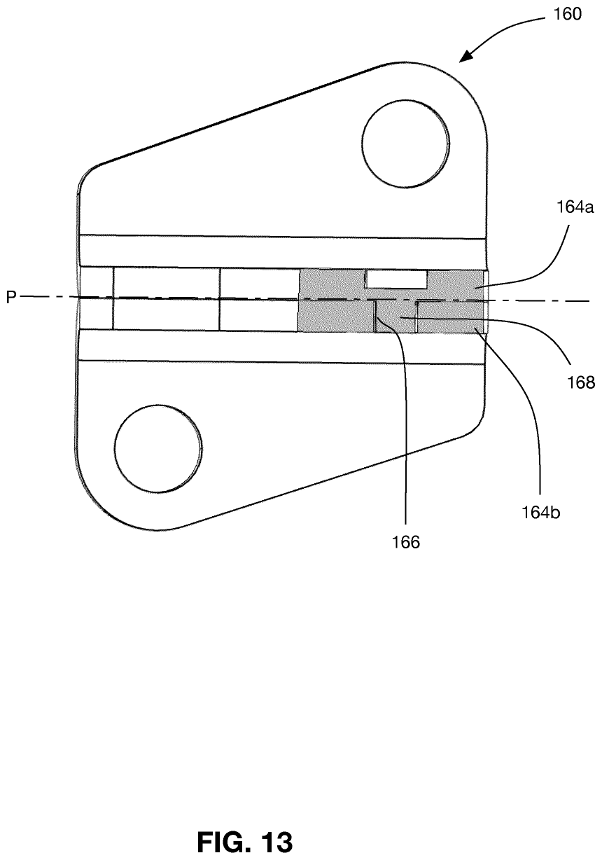

The body-hinge component 160 may be similar to the body-hinge component 71 shown in FIGS. 7 and 8, but has an additional feature to assist in holding the first layer (shown at 164a) and the second layer (shown at 164b) together. As in the embodiment in FIGS. 7 and 8, the first and second layers 164a and 164 extend from a fold shown at 165. The aforementioned additional feature is provided by providing one of the first and second layers 164a and 164b with a layer-locking aperture 166 therein, and the other of the first and second layers 164a and 164b with a deformation 168 that projects into the layer-locking aperture 166. The layer-locking aperture 166 and the deformation 168 together cooperate with the fold 165 so as to lock the first and second layers 164a and 164b together in at least one plane of movement. The plane of movement is shown at P in FIG. 13. It is the plane that is parallel to the main regions of the first and second layers 164a and 164b and includes the fold 165. FIG. 13 is a sectional view which would normally not show the fold 165 due to the position of the section plane, however, the fold 165 is represented in FIG. 13 in in dashed lines so as to show that the plane P passes through it. The deformation 168 may be provided by a stamping step during manufacturing of the vehicular door hinge 150.

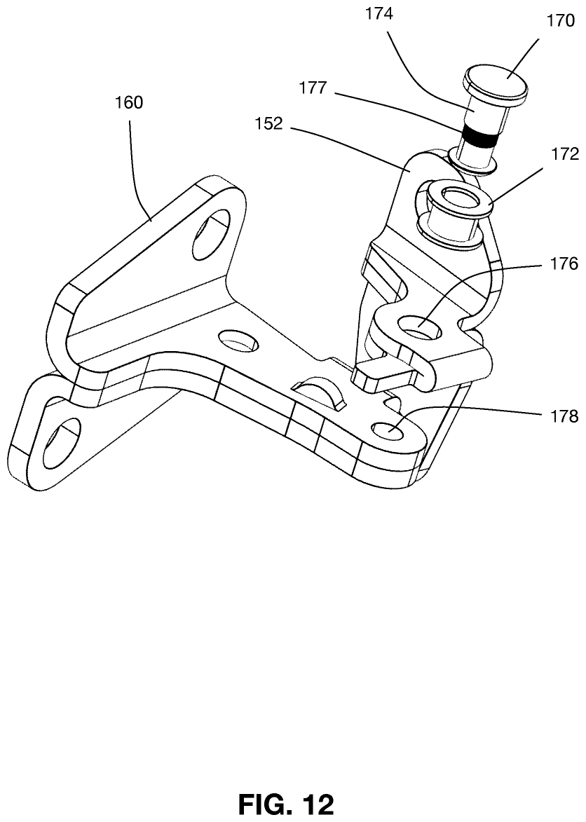

Referring to FIGS. 11 and 12, the stop surface 158 on the body-hinge component 160 may be provided in any suitable, such as by lancing a region of the first layer 164a of the body hinge component 160.

The body hinge component 160 is connected pivotally to the door-hinge component 152 via a hinge pin 170 that may be similar to the hinge pin 82, or to any of the other hinge pins shown and/or described herein. The hinge pin 170 is positioned inside of a bushing 172 which is provided between the first bearing surface (shown at 174) of the body of the hinge pin 170, and the first hinge pin aperture shown at 176 in FIG. 12, in the door-hinge component 18. The bushing 172 may be any suitable type of bushing. For example, the bushing 172 may be similar to the bushings 94 and 56. As with the other hinge pins shown and described herein, the hinge pin 170 has a second bearing surface 177 that engages a second hinge pin aperture 178 in the body-hinge component 160.

The second bearing surface 177 may be a knurled surface to increase the amount of grip between it and the second hinge pin aperture 178, so as to ensure that the hinge pin 170 remains fixed rotationally to the body-hinge component 162. Alternatively any other suitable surface treatment may be provided on the second bearing surface 177 and/or on the second hinge pin aperture 178 to improve the grip therebetween.

The mounting of the hinge pin 170 may be by hammering the rivet head at the second end of the hinge pin 170, so as to permanently capture the door-hinge component 152 and the body-hinge component 160 together with the hinge pin 170.

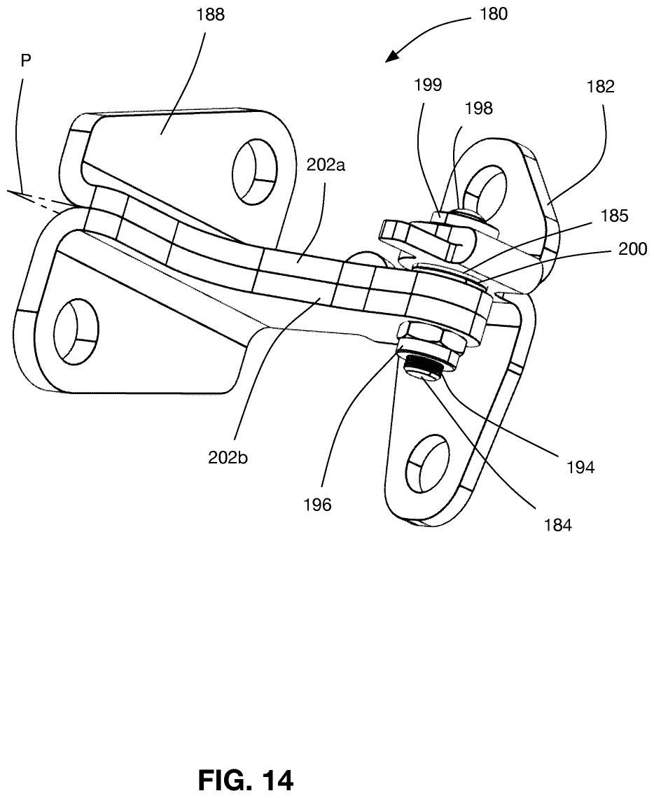

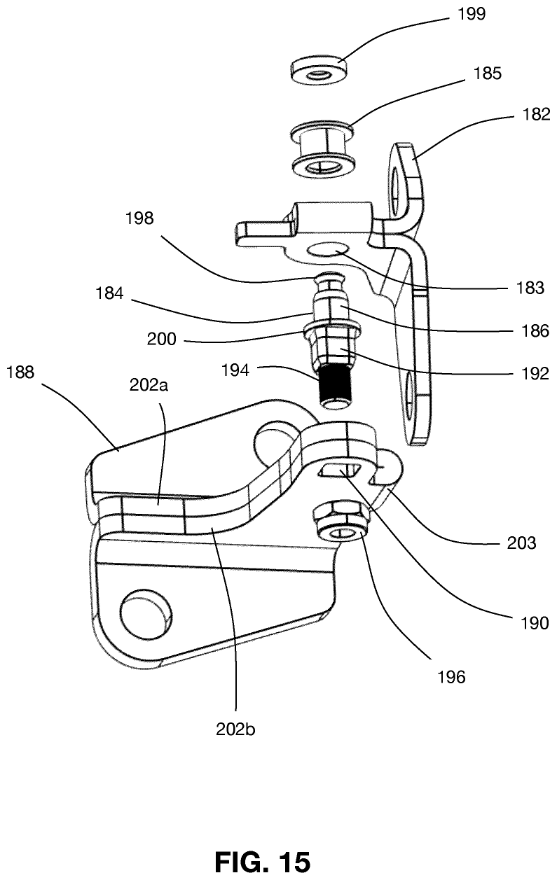

Reference to FIGS. 14 and 15, which show a vehicular door hinge 180 in accordance with another embodiment of the present disclosure. In the vehicular door hinge 180 a door-hinge component 182 is provided that may be similar to any of the door-hinge components described and/or shown herein. In the example shown, the door hinge component 182 is similar to the door-hinge component 152 shown in FIGS. 11 and 12. The door hinge component 182 includes a first hinge pin aperture shown at 183, which may be similar to the first hinge pin apertures shown and described elsewhere herein, and is sized to receive a hinge pin, shown at 184, and a bushing shown at 185 (FIG. 15). The bushing 185 is positioned on a first bearing surface 186 of the hinge pin 184. The bushing 185, the first bearing surface 186 and the first hinge pin aperture 183 may be similar to their counterparts in the other figures of the present disclosure. The vehicular door hinge 180 further includes a body-hinge component 188 that may be similar to the body-hinge component 160 (FIGS. 11-13) or the body-hinge component 71 (FIGS. 7 and 8). A difference with the body-hinge component 188 is that it includes a second hinge pin aperture 190 that is non-round, and receives a second bearing surface 192 of the hinge pin 184 that is shaped complementarily to the second hinge pin aperture 190 so as to lock the hinge pin 184 rotationally with the body-hinge component 188 (thereby preventing rotation of the hinge pin 184 during movement of the vehicle door). In the example shown, the second hinge pin aperture 190 and the second bearing surface 192 have a square shape with rounded corners, however, any other suitable shape may be used, such as a triangular shape, an elliptical shape or any suitable non-regular shape, such as a trapezoid.

A threaded region 194 is provided at one end of the hinge pin 184, which receives a nut 196 so as to releasably prevent withdrawal of the hinge pin 184 from the second hinge pin aperture 190, thereby releasably holding the door-hinge component 182 to the body-hinge component 188. The other end of the hinge pin 184 may have a head 198 that is a rivet head which is deformed against a washer 199 during assembly of the vehicular door hinge 180. The head 198 (once it is deformed), cooperates with a flange 200 on the hinge pin 184 to retain the hinge pin 184 on the door-hinge component 182. Upon removal of the nut 196, the door-hinge component 182 and the hinge pin 184 may be removed together as one subassembly from the second hinge pin aperture 190, thereby permitting removal of the vehicle door from the body of the vehicle. The vehicular door hinge 180 may therefore be referred to as a lift-off type of hinge.

The body-hinge component 188 includes a first layer 202a and a second layer 202b, which extend from a fold shown at 203. There is no layer-locking aperture in one of the first and second layers 202a and 202b, nor a deformation that extends from the other of the first and second layers 202a and 202b into a layer-locking aperture. Instead, the presence of the non-round, second hinge-pin aperture 190 that passes through both the first and second layers 202a and 202b, and the presence of the non-round, complementary, second bearing surface 192 of the hinge pin 184 in the second hinge pin aperture 190 locks the two layers together in relation to movement in the plane P. Additionally, the prevention of rotation of the hinge pin 184 relative to the body-hinge component 188 ensures that pivoting movement of the door-hinge component 184 does not over time result in turning of the hinge pin 184 relative to the nut 196 in a loosening direction.

In another embodiment, however, the layer-locking aperture and the deformation described above and shown in FIG. 13, may be provided in order to the lock the two layers together in the plane P, and the non-round, second hinge-pin aperture 190 and the non-round, complementary second bearing surface 192 may therefore be replaced by a round, second hinge-pin aperture 190 and a round second bearing surface.

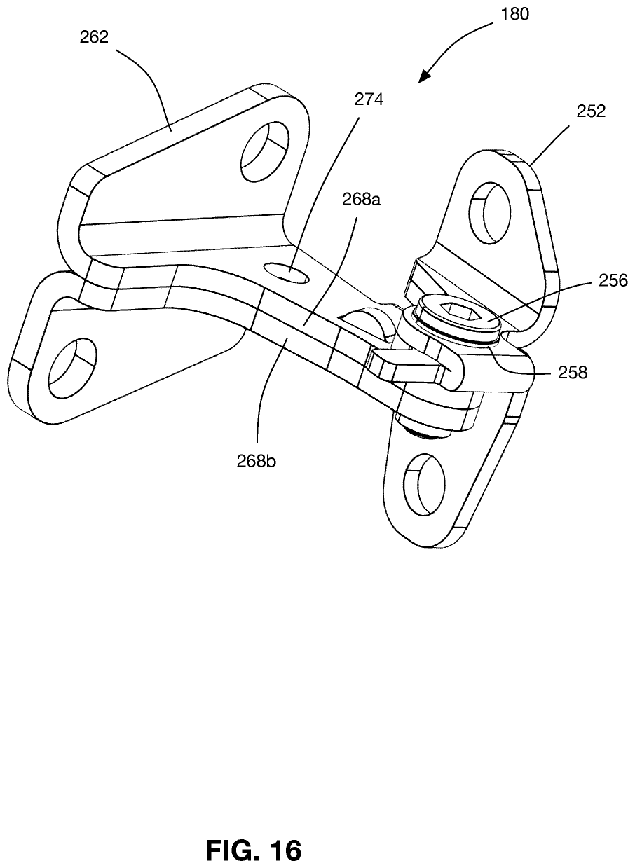

Reference is made to FIGS. 16-18, which show a vehicular door hinge 250 in accordance with another embodiment of the present disclosure. In the vehicular door hinge 250 a door-hinge component 252 is provided that may be similar to any of the door-hinge components described and/or shown herein. In the example shown, the door hinge component 182 is similar to the door-hinge component 152 shown in FIGS. 11 and 12, and the door hinge component 182 shown in FIGS. 14 and 15. The door hinge component 252 includes a first hinge pin aperture shown at 254, which may be similar to the first hinge pin apertures shown and described elsewhere herein, and is sized to receive a hinge pin, shown at 256, and a bushing shown at 258. The bushing 258 is positioned on a first bearing surface 260 of the hinge pin 256. The bushing 258, the first bearing surface 260 and the first hinge pin aperture 254 may be similar to their counterparts in the other figures of the present disclosure.

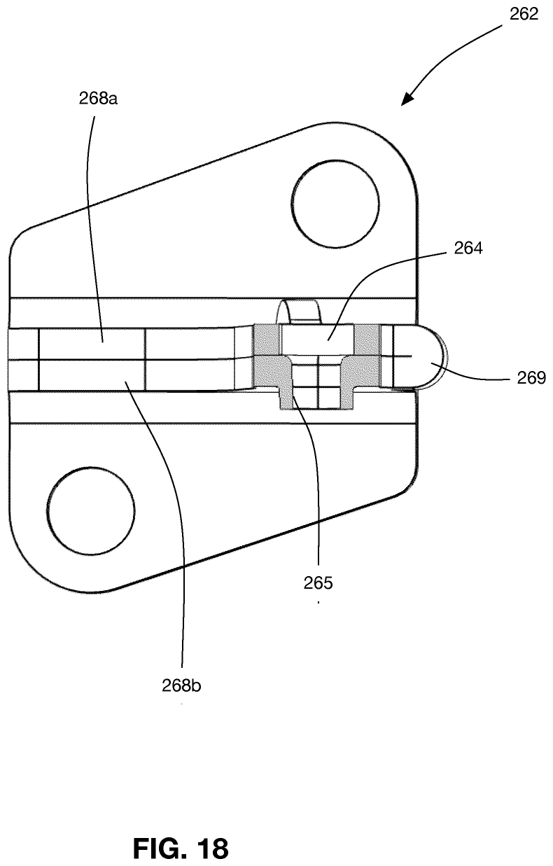

The vehicular door hinge 250 further includes a body-hinge component 262 that may be similar to the body-hinge component 160 (FIGS. 11-13). A difference with the body-hinge component 262 is that it includes a second hinge pin aperture 264 that includes a threaded surface 265 (FIG. 18), and the hinge pin 256 has a second bearing surface 266 which includes a threaded surface 267, which threadingly receives the hinge pin 256 so as to lock the hinge pin 256 to the body-hinge component 262 (i.e. thereby preventing rotation of the hinge pin 256 during movement of the vehicle door). A suitable thread adhesive such as Loctite™ may be used if needed to ensure that the pivoting movement of the door-hinge component 252 does not over time loosen the hinge pin 256 from the body-hinge component 262.

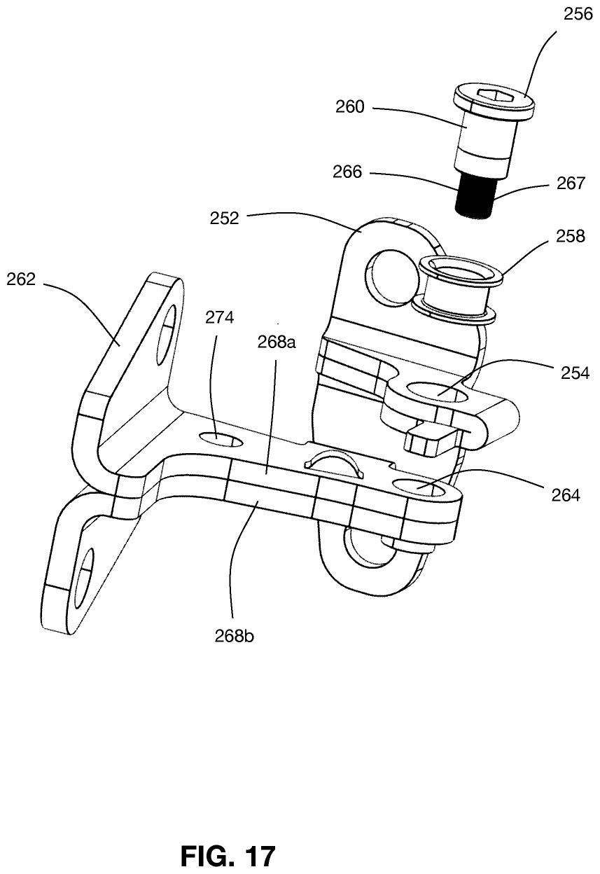

The body-hinge component 262 is provided with a first layer 268a and a second layer 268b, which extend from a fold 269. The threaded surface 265 of the second hinge pin aperture 264 is shown as being provided in the second layer 268b and not in the first layer 268a. There is some clearance between the portion of the second hinge pin aperture 264 in the first layer 268a, and the hinge pin 256. In order to assist in fixing the first and second layers 268a and 268b together, the body-hinge component 262 may include a layer-locking aperture on one of the first and second layers 268a and 268b, and a deformation that projects into the layer-locking aperture from the other of the first and second layers 268a and 268b. The layer-locking aperture and the deformation may be similar to the layer-locking aperture 166 and the deformation 168 shown in FIG. 13. A portion of the deformation is partly visible in FIGS. 16 and 17.

Based on the embodiments described and shown, in an aspect, a vehicular door hinge, shown at 16, 70, 100, 150, 180, 250, is provided, and includes a door-hinge component 18, 152, 182, 252 that is configured to mount to a vehicle door 14, and a body-hinge component 20, 71, 102, 160, 188, 262 that is configured to mount to a vehicle body. The door hinge component 18, 152, 182, 252 is pivotally mounted to the body hinge component 20, 71, 102, 160, 188, 262. A first one of the door- and body-hinge components is made from folded sheet metal and has a fold. Each of the door- and body-hinge components has a stop surface that is engageable with the stop surface on the other of the door- and body-hinge components to limit relative pivoting movement between the door- and body-hinge components. The stop surface on the first of the door- and body-hinge components is at the fold. The door-hinge component 18 shown in FIGS. 1-5 illustrate such a stop surface at 36, which is present at the fold 24. It will be understood that this arrangement for the stop surface 36 being at the fold 24 can be provided on any of the other door-hinge components described herein.

Optionally, the other one of the door- and body-hinge components is made from folded sheet metal, as can be seen, in the embodiments shown in FIGS. 6-18, where both the door-hinge component and the body-hinge component are made from folded sheet metal. As a further option, the stop surface on the other one of the door- and body-hinge components is provided on a lanced region of the other one of the door- and body-hinge components. This can be seen in all of the embodiments shown in FIGS. 6-18, for the stop surface on the body-hinge component. As a yet further option, the other one of the door- and body-hinge components includes a first layer and a second layer, and wherein the lanced region is provided only on one of the first and second layers. This again is shown in all of the embodiments shown in FIGS. 6-18.

Optionally, a hinge pin is provided and passes through a first hinge pin aperture in the door-hinge component and through a second hinge pin aperture in the body-hinge component, as is shown in all of the embodiments shown in FIGS. 1-18. The hinge pin has a hinge pin body with a first end and a second end, and has a first flange extending outward from the hinge pin body at a point that is between the first and second ends, and a second flange at the first end. The first and second flanges capture the first one of the door- and body-hinge components. In the embodiments shown, the first and second flanges (e.g. shown at 48 and 50 in FIGS. 1-5) capture the door-hinge component (e.g. shown at 18 in FIGS. 1-5), though it is alternatively possible for the first and second flanges to capture the body-hinge component (e.g. shown at 20 in FIGS. 1-5). The hinge pin body has a first bearing surface between the first and second flanges and a second bearing surface between the second flange and the second end. The second bearing surface has a depression (e.g. shown at 58 in FIGS. 3 and 4) between the second flange and the second end. The vehicular door hinge further comprises a locking screw that passes through a threaded aperture in the other of the door- and body-hinge components and into the depression so as to releasably lock the hinge pin to the other of the door- and body-hinge components, wherein the locking screw is removable to permit removal of the hinge pin from the other of the door- and body-hinge components, so as to permit removal of the vehicle door from the vehicle body. Further optionally, a bushing (e.g. bushing (e.g. shown at 56 in FIGS. 1-5) is mounted between the hinge pin and the first door-hinge aperture.

Optionally, the vehicular door hinge further includes a hinge pin that passes through a first hinge pin aperture in the door-hinge component and through a second hinge pin aperture in the body-hinge component. The hinge pin has a hinge pin body with a first end and a second end, and has a first flange extending outward from the hinge pin body at a point that is between the first and second ends, and a second flange at the first end. The first and second flanges capture the first one of the door- and body-hinge components. The hinge pin body has a first bearing surface between the first and second flanges and a second bearing surface between the second flange and the second end. The second bearing surface has a depression between the second flange and the second end. The other of the door- and body-hinge components is formed from a first layer and a second layer of sheet metal and an aperture plate that contains a threaded aperture that is mounted to the first and second layers of sheet metal. The vehicular door hinge further comprises a locking screw that passes through the threaded aperture and into the depression so as to releasably lock the hinge pin to the other of the door- and body-hinge components. The locking screw is removable to permit removal of the hinge pin from the other of the door- and body-hinge components, so as to permit removal of the vehicle door from the vehicle body. As a further option, the aperture plate includes the stop surface on the other of the door- and body-hinge components.

Optionally, the other of the door- and body-hinge components is a monolithic element (e.g. as shown at 20 in FIGS. 1-5).

Optionally, the first one of the door- and body-hinge components is the door-hinge component, and the other one of the door- and body-hinge components is the body-hinge component.

As noted above, optionally, the other one of the door- and body-hinge components is made from folded sheet metal, as can be seen, in the embodiments shown in FIGS. 6-18, where both the door-hinge component and the body-hinge component are made from folded sheet metal. As a further option, the other one of the door- and body-hinge components is formed from a first layer of sheet metal and a second layer of sheet metal, and the stop surface for the other one of the door- and body-hinge components is provided on a lanced region of the first layer only.

Optionally, the first one of the door- and body-hinge components includes a first layer of sheet metal and a second layer of sheet metal, and one of the first and second layers has a layer-locking aperture (e.g. shown at 166 and 272) therein, and the other of the first and second layers has a deformation (e.g. shown at 168 and 274) that projects into the layer-locking aperture so as to lock the first and second layers together in at least one plane of movement.

Optionally, the vehicular door hinge further includes a hinge pin having a first bearing surface and a second bearing surface. The hinge pin passes through a first hinge pin aperture in the door-hinge component and through a second hinge pin aperture in the body-hinge component. One of the first and second hinge pin apertures is non-round (e.g. such as the second hinge pin aperture 190). A corresponding one of the first and second bearing surfaces (e.g. such as the second bearing surface 192) is non-round and complementary to said one of the first and second hinge pin apertures so as to rotationally lock the hinge pin to whichever of the door- and body-hinge components has said one of the first and second hinge pin apertures.

Optionally, the vehicular door hinge further includes a hinge pin having a first bearing surface and a second bearing surface. The hinge pin passes through a first hinge pin aperture in the door-hinge component and through a second hinge pin aperture in the body-hinge component. One of the first and second hinge pin apertures has a threaded surface. A corresponding one of the first and second bearing surfaces is threaded so as to permit locking of the hinge pin to said one of the first and second hinge pin apertures. As a further option, the first one of the door- and body-hinge components may include a first layer of sheet metal and a second layer of sheet metal. Only one of the first and second layers has the threaded surface.

Based on the embodiments described and shown, in another aspect, a vehicular door hinge, shown at 16, 70, 100, 150, 180, 250, is provided, and includes a door-hinge component 18, 152, 182, 252 252 that is configured to mount to a vehicle door 14, and a body-hinge component 20, 71, 102, 160, 188, 262 that is configured to mount to a vehicle body. The door hinge component 18, 152, 182, 252 is pivotally mounted to the body hinge component 20, 71, 102, 160, 188, 262. A first one of the door- and body-hinge components is made from folded sheet metal and has a fold. Each of the door- and body-hinge components has a stop surface that is engageable with the stop surface on the other of the door- and body-hinge components to limit relative pivoting movement between the door- and body-hinge components. The first one of the door- and body-hinge components includes a first layer of sheet metal and a second layer of sheet metal. One of the first and second layers has a layer-locking aperture (e.g. shown at 166 and 272) therein, and the other of the first and second layers has a deformation (e.g. shown at 168 and 274) that projects into the layer-locking aperture so as to lock the first and second layers together in at least one plane of movement.

Based on the embodiments described and shown, in yet another aspect, a vehicular door hinge, shown at 16, 70, 100, 150, 180, 250, is provided, and includes a door-hinge component 18, 152, 182, 252 252 that is configured to mount to a vehicle door 14, and a body-hinge component 20, 71, 102, 160, 188, 262 that is configured to mount to a vehicle body. The door hinge component 18, 152, 182, 252 is pivotally mounted to the body hinge component 20, 71, 102, 160, 188, 262. A first one of the door- and body-hinge components is made from folded sheet metal and has a fold. Each of the door- and body-hinge components has a stop surface that is engageable with the stop surface on the other of the door- and body-hinge components to limit relative pivoting movement between the door- and body-hinge components. Optionally the vehicular door hinge includes a hinge pin having a first bearing surface and a second bearing surface, wherein the hinge pin passes through a first hinge pin aperture in the door-hinge component and through a second hinge pin aperture in the body-hinge component, wherein one of the first and second hinge pin apertures is non-round, and wherein a corresponding one of the first and second bearing surfaces is non-round and complementary to said one of the first and second hinge pin apertures so as to rotationally lock the hinge pin to whichever of the door- and body-hinge components has said one of the first and second hinge pin apertures. Optionally, said one of the first and second hinge pin apertures is the second hinge pin aperture and said one of the first and second bearing surfaces is the second bearing surface.

Persons skilled in the art will appreciate that there are yet more alternative implementations and modifications possible, and that the above examples are only illustrations of one or more implementations. The scope, therefore, is only to be limited by the claims appended hereto and any amendments made thereto.

1. A vehicular door hinge, comprising:
a door-hinge component that is configured to mount to a vehicle door; and
a body-hinge component that is configured to mount to a vehicle body, wherein the door hinge component is pivotally mounted to the body hinge component, wherein a first one of the door- and body-hinge components is made from folded sheet metal and has a fold, and wherein each of the door- and body-hinge components has a stop surface that is engageable with the stop surface on the other of the door- and body-hinge components to limit relative pivoting movement between the door- and body-hinge components, wherein the stop surface on the first of the door- and body-hinge components is at the fold.

2. A vehicular door hinge as claimed in claim 1, wherein the other one of the door- and body-hinge components is made from folded sheet metal.

3. A vehicular door hinge as claimed in claim 2, wherein the stop surface on the other one of the door- and body-hinge components is provided on a lanced region of the other one of the door- and body-hinge components.

4. A vehicular door hinge as claimed in claim 3, wherein the other one of the door- and body-hinge components includes a first layer and a second layer, and wherein the lanced region is provided only on one of the first and second layers.

5. A vehicular door hinge as claimed in claim 1, further comprising a hinge pin that passes through a first hinge pin aperture in the door-hinge component and through a second hinge pin aperture in the body-hinge component, wherein the hinge pin has a hinge pin body with a first end and a second end, and has a first flange extending outward from the hinge pin body at a point that is between the first and second ends, and a second flange at the first end, wherein the first and second flanges capture the first one of the door- and body-hinge components,
and wherein the hinge pin body has a first bearing surface between the first and second flanges and a second bearing surface between the second flange and the second end, wherein the second bearing surface has a depression between the second flange and the second end,
and wherein the vehicular door hinge further comprises a locking screw that passes through a threaded aperture in the other of the door- and body-hinge components and into the depression so as to releasably lock the hinge pin to the other of the door- and body-hinge components, wherein the locking screw is removable to permit removal of the hinge pin from the other of the door- and body-hinge components, so as to permit removal of the vehicle door from the vehicle body.

6. A vehicular door hinge as claimed in claim 5, further comprising a bushing mounted between the hinge pin and the first door-hinge aperture.

7. A vehicular door hinge as claimed in claim 1, further comprising a hinge pin that passes through a first hinge pin aperture in the door-hinge component and through a second hinge pin aperture in the body-hinge component, wherein the hinge pin has a hinge pin body with a first end and a second end, and has a first flange extending outward from the hinge pin body at a point that is between the first and second ends, and a second flange at the first end, wherein the first and second flanges capture the first one of the door- and body-hinge components,
and wherein the hinge pin body has a first bearing surface between the first and second flanges and a second bearing surface between the second flange and the second end, wherein the second bearing surface has a depression between the second flange and the second end,
and wherein the other of the door- and body-hinge components is formed from a first layer and a second layer of sheet metal and an aperture plate that contains a threaded aperture that is mounted to the first and second layers of sheet metal,
wherein the vehicular door hinge further comprises a locking screw that passes through the threaded aperture and into the depression so as to releasably lock the hinge pin to the other of the door- and body-hinge components, wherein the locking screw is removable to permit removal of the hinge pin from the other of the door- and body-hinge components, so as to permit removal of the vehicle door from the vehicle body.

8. A vehicular door hinge as claimed in claim 7, wherein the aperture plate includes the stop surface on the other of the door- and body-hinge components.

9. A vehicular door hinge as claimed in claim 1, wherein the other of the door- and body-hinge components is a monolithic element.

10. A vehicular door hinge as claimed in claim 1, wherein the first one of the door- and body-hinge components is the door-hinge component, and the other one of the door- and body-hinge components is the body-hinge component.

11. A vehicular door hinge as claimed in claim 2, wherein the other one of the door- and body-hinge components is formed from a first layer of sheet metal and a second layer of sheet metal, and wherein the stop surface for the other one of the door- and body-hinge components is provided on a lanced region of the first layer only.

12. A vehicular door hinge as claimed in claim 1, wherein the first one of the door- and body-hinge components includes a first layer of sheet metal and a second layer of sheet metal, and wherein one of the first and second layers has a layer-locking aperture therein, and the other of the first and second layers has a deformation that projects into the layer-locking aperture so as to lock the first and second layers together in at least one plane of movement.

13. A vehicular door hinge as claimed in claim 1, further comprising a hinge pin having a first bearing surface and a second bearing surface, wherein the hinge pin passes through a first hinge pin aperture in the door-hinge component and through a second hinge pin aperture in the body-hinge component, wherein one of the first and second hinge pin apertures is non-round, and wherein a corresponding one of the first and second bearing surfaces is non-round and complementary to said one of the first and second hinge pin apertures so as to rotationally lock the hinge pin to whichever of the door- and body-hinge components has said one of the first and second hinge pin apertures.

14. A vehicular door hinge as claimed in claim 1, further comprising a hinge pin having a first bearing surface and a second bearing surface, wherein the hinge pin passes through a first hinge pin aperture in the door-hinge component and through a second hinge pin aperture in the body-hinge component, wherein one of the first and second hinge pin apertures has a threaded surface, and wherein a corresponding one of the first and second bearing surfaces is threaded so as to permit locking of the hinge pin to said one of the first and second hinge pin apertures.

15. A vehicular door hinge as claimed in claim 14, wherein the first one of the door- and body-hinge components includes a first layer of sheet metal and a second layer of sheet metal, and wherein only one of the first and second layers has the threaded surface.

16. A vehicular door hinge, comprising:
a door-hinge component that is configured to mount to a vehicle door; and
a body-hinge component that is configured to mount to a vehicle body, wherein the door hinge component is pivotally mounted to the body hinge component, wherein a first one of the door- and body-hinge components is made from folded sheet metal and has a fold, and wherein each of the door- and body-hinge components has a stop surface that is engageable with the stop surface on the other of the door- and body-hinge components to limit relative pivoting movement between the door- and body-hinge components,
wherein the first one of the door- and body-hinge components includes a first layer of sheet metal and a second layer of sheet metal, and wherein one of the first and second layers has a layer-locking aperture therein, and the other of the first and second layers has a deformation that projects into the layer-locking aperture so as to lock the first and second layers together in at least one plane of movement.

17. A vehicular door hinge, comprising:
a door-hinge component that is configured to mount to a vehicle door;
a body-hinge component that is configured to mount to a vehicle body, wherein the door hinge component is pivotally mounted to the body hinge component, wherein a first one of the door- and body-hinge components is made from folded sheet metal and has a fold, and wherein each of the door- and body-hinge components has a stop surface that is engageable with the stop surface on the other of the door- and body-hinge components to limit relative pivoting movement between the door- and body-hinge components; and
a hinge pin having a first bearing surface and a second bearing surface, wherein the hinge pin passes through a first hinge pin aperture in the door-hinge component and through a second hinge pin aperture in the body-hinge component, wherein one of the first and second hinge pin apertures is non-round, and wherein a corresponding one of the first and second bearing surfaces is non-round and complementary to said one of the first and second hinge pin apertures so as to rotationally lock the hinge pin to whichever of the door- and body-hinge components has said one of the first and second hinge pin apertures.

18. A vehicular door hinge as claimed in claim 17, wherein said one of the first and second hinge pin apertures is the second hinge pin aperture and said one of the first and second bearing surfaces is the second bearing surface.
